(19) United States
(12) Patent Application Publication
(10) Pub. No.: US 2022/0315130 A1
(43) Pub. Date: Oct. 6, 2022

(54) VEHICLE BODY STRUCTURE

(71) Applicant: MAZDA MOTOR CORPORATION, Hiroshima (JP)

(72) Inventors: Isao TODA, Hiroshima (JP); Takayuki KIMURA, Hiroshima (JP); Takehiro KAMEI, Hiroshima (JP); Hiroshi TANAKA, Hiroshima (JP); Haruo OHE, Hiroshima (JP); Masaya HIRAMATSU, Hiroshima (JP); Masanobu FUKUSHIMA, Hiroshima (JP); Takao FUKUDA, Hiroshima (JP); Hironobu HASHIGUCHI, Hiroshima (JP); Hiroyuki BABA, Hiroshima (JP)

(73) Assignee: MAZDA MOTOR CORPORATION, Hiroshima (JP)

(21) Appl. No.: 17/584,970

(22) Filed: Jan. 26, 2022

(30) Foreign Application Priority Data
Mar. 30, 2021 (JP) 2021-057811

(51) Int. Cl. B62D 25/20; B60N 2/06; B60N 2/005

(52) U.S. Cl. CPC B62D 25/2009; B60N 2/06; B60N 2/005

(57) ABSTRACT

A vehicle body structure includes a front floor panel for placing a heel of a pedal operator, a rear floor panel attached to a rear seat, and a middle floor panel extending from the front floor panel to the rear floor panel. The front floor panel and the rear floor panel are positioned higher than the middle floor panel.

### CROSS-REFERENCE TO RELATED APPLICATION

This application claims priority to Japanese Patent Application No. 2021-057811 filed on Mar. 30, 2021, the entire disclosure of which is incorporated by reference herein.

### BACKGROUND

The present disclosure relates to a vehicle body structure including a floor panel, for example.

In a motor vehicle having a rear seat, a front seat is attached to a front portion of a floor panel, and the rear seat is attached to a rear portion of the floor panel positioned away rearward from the front seat (e.g. see Japanese Unexamined Patent Publication No. 2005-178581).

A vehicle body structure of Japanese Unexamined Patent Publication No. 2005-178581 includes a floor position adjuster capable of adjusting the height of a floor on which a leg of an occupant operating a pedal is placed. Japanese Unexamined Patent Publication No. 2005-178581 describes that, in general, the occupant is in an ergonomically comfortable state in a posture with a wide angle between an upper leg from the pelvis to a knee and a lower leg from a knee to an ankle when the seating position of the occupant is low. The floor position adjuster is provided to optimize this angle.

### SUMMARY

According to inventor's study on the posture of the occupant upon pedal operation, it has found that, by raising a heel of the occupant operating the pedal to a position higher than a general position and lowering the hip point of the occupant, an angle between the lower leg and the floor becomes small and the pedal operability is improved accordingly. That is, the pedal operation in a vehicle is the operation of pushing the pedal forward of the vehicle, and at this point, the heel is placed on the floor in most cases. Thus, counterforce from the pedal acts on a foot sole, and counterforce from the floor mainly acts on the heel. In general, a pedal operation direction is not the horizontal direction but an obliquely-downward direction, and the small angle between the lower leg and the floor during the pedal operation results in small up-down component force input from the heel. This allows, e.g., the quick and accurate operation of switching the pedal to be stepped on from a brake pedal to an accelerator pedal or from the accelerator pedal to the brake pedal. As a result, the operability of the pedals is improved.

An approach for raising the position of the heel of the occupant operating the pedal is to provide the floor position adjuster of Japanese Unexamined Patent Publication No. 2005-178581. However, for providing such a floor position adjuster of Japanese Unexamined Patent Publication No. 2005-178581, there is a need for incorporating, in a vehicle body, a lifting/lowering mechanism for lifting/lowering the floor, a lock mechanism for locking the floor at a desired height, etc. In some vehicles, it is difficult to ensure spaces for these mechanisms.

Focusing on the comfort of an occupant seated on a rear seat, there is a demand for a widest possible foot space for the rear seat occupant, which imposes a layout requirement that is totally different from that for the front seat.

In view of the above-described points, it is an object of the present disclosure to improve pedal operability for an occupant operating a pedal while ensuring a wide foot space for a rear seat occupant.

To achieve the above-described object, a first aspect of the present disclosure may premise a vehicle body structure including a floor panel forming a floor surface of a vehicle interior in which a front seat and a rear seat are provided. The vehicle body structure includes a front floor panel on which a heel of a pedal operator operating a pedal provided in the vehicle is placed, a rear floor panel provided away rearward from the front floor panel and attached to the rear seat, and a middle floor panel extending from a rear portion of the front floor panel to a front portion of the rear floor panel. The front floor panel and the rear floor panel are positioned higher than the middle floor panel.

According to this configuration, the front floor panel for placing the heel of the pedal operator is positioned higher than the middle floor panel. Thus, the heel of the pedal operator is placed at a high position. This results in a small angle between a lower leg of the pedal operator and the front floor panel, which leads to small up-down component force input from a heel upon pedal operation. Thus, pedal operability is improved.

Further, since the rear floor panel attached to the rear seat is positioned higher than the middle floor panel, an occupant on the rear seat is seated at a relatively-high position. The feet of the rear seat occupant are placed on the middle floor panel. Since the middle floor panel is positioned lower than the rear floor panel, a wide foot space for the rear seat occupant is ensured particularly in the height direction.

In a second aspect of the present disclosure, the intermediate floor pan has a seat fixing portion for fixing the front seat.

According to this configuration, since the seat fixing portion is provided on the middle floor panel positioned lower than the front floor panel, the hip point of the pedal operator seated on the front seat is lowered. This can achieve a sufficiently-small angle between a lower leg of the pedal operator and the front floor panel.

In a third aspect of the present disclosure, the front seat includes a front-seat cushion portion and a seat slide mechanism configured to adjust a position of the front-seat cushion portion in a vehicle front-rear direction. The middle floor panel includes a front seat fixing portion for fixing a front portion of the seat slide mechanism and a rear seat fixing portion for fixing a rear portion of the seat slide mechanism.

According to this configuration, since the front and rear portions of the seat slide mechanism can be fixed to the middle floor panel, the hip point of the pedal operator seated on the front seat can be reliably lowered. As a result, a sufficiently-small angle between the lower leg of the pedal operator and the front floor panel can be achieved.

In a fourth aspect of the present disclosure, the front floor panel is positioned higher than the seat slide mechanism.

According to this configuration, since the entire seat slide mechanism can be arranged in a position lower than the front floor panel, the hip point of the pedal operator seated on the front seat can be further lowered.

In a fifth aspect of the present disclosure, the front floor panel has, at a portion corresponding to the brake pedal, a recessed portion for placing a heel of the pedal operator.

According to this configuration, the heel is less likely to shift in the vehicle width direction. This can make the foot stable in the case of turning a toe in the vehicle width direction about the vicinity of the heel, such as the case of stepping on an accelerator pedal after having stepped on a brake pedal, for example. As a result, the pedal operability can be further improved by a synergy effect with the advantage of the small angle between the lower leg of the pedal operator and the front floor panel.

A sixth aspect of the present disclosure may premise a vehicle body structure including a floor panel forming a floor surface of a vehicle interior in which a front seat and a rear seat are provided. the floor panel includes a front panel portion for placing a heel of a pedal operator operating a pedal provided in the vehicle, a rear panel portion provided away rearward from the front panel portion and attached to the rear seat, and a middle panel portion extending from a rear portion of the front panel portion to a front portion of the rear panel portion. The front panel portion and the rear panel portion are positioned higher than the middle panel portion.

According to this configuration, one configured such that the floor panel is integrally formed from the front portion to the rear portion can provide features and advantages similar to those of the first aspect.

As described above, the pedal operability can be improved by the small angle between the lower leg of the pedal operator and the front floor panel while a wide foot space for the occupant seated on the rear seat is ensured.

### BRIEF DESCRIPTION OF THE DRAWINGS

FIG. 1 is a side view of a motor vehicle of an embodiment of the present disclosure.

FIG. 2 is a partial cross-sectional view of a dash panel and a floor panel of the motor vehicle, FIG. 2 showing the position of a brake pedal.

FIG. 3 is a partial cross-sectional view of the dash panel and the floor panel of the motor vehicle, FIG. 3 showing the position of an accelerator pedal.

FIG. 4 is a cross-sectional view showing an exemplary structure of the floor panel.

FIG. 5 is a view for describing pedal operation.

FIG. 6 is a view corresponding to FIG. 5, which relates to Variation 1 of the embodiment.

FIG. 7 is a view corresponding to FIG. 4, which relates to Variation 2 of the embodiment.

### DETAILED DESCRIPTION

An embodiment of the present disclosure will be described in detail below with reference to the drawings. Note that the following description of the preferred embodiment is only an example in nature, and is not intended to limit the scope, applications or use of the present disclosure.

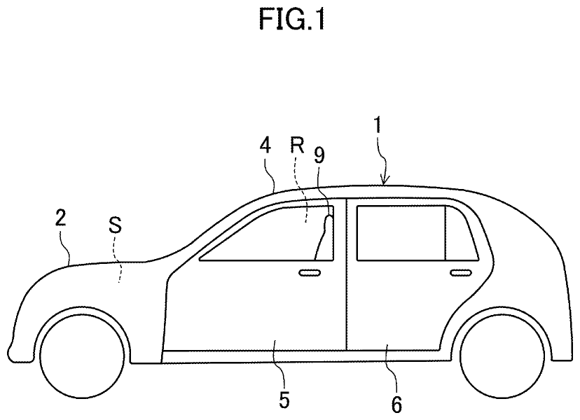

FIG. 1 is a left side view of a motor vehicle 1 of an embodiment of the present disclosure. The motor vehicle 1 is a so-called passenger car. Note that in the description of this embodiment, the front side of the vehicle is simply referred to as “front,” the rear side of the vehicle is simply referred to as “rear,” the right side of the vehicle is simply referred to as “right,” and the left side of the vehicle is simply referred to as “left.” A right-left direction of the vehicle is a vehicle width direction.

In a front portion of the motor vehicle 1, a power house S is provided. In the power house S, a power train (not shown) including an internal combustion engine, a traction motor, etc. is stored. Thus, the power house S can also be referred to as, e.g., a power train storage compartment, an engine room, or a motor room. Provided above the power house S is a hood 2. The motor vehicle 1 may be such a front-engine rear-drive vehicle (hereinafter referred to as an FR vehicle) that an engine, a traction motor, etc. mounted in a power house S drives rear wheels, or such a front-engine front-drive vehicle (hereinafter referred to as an FF vehicle) that an engine, a traction motor, etc. mounted in a power house S drives front wheels. In addition to the FR vehicle and the FF vehicle, the motor vehicle 1 may also be a 4-wheel drive vehicle configured such that an engine mounted in a power house S drives four wheels.

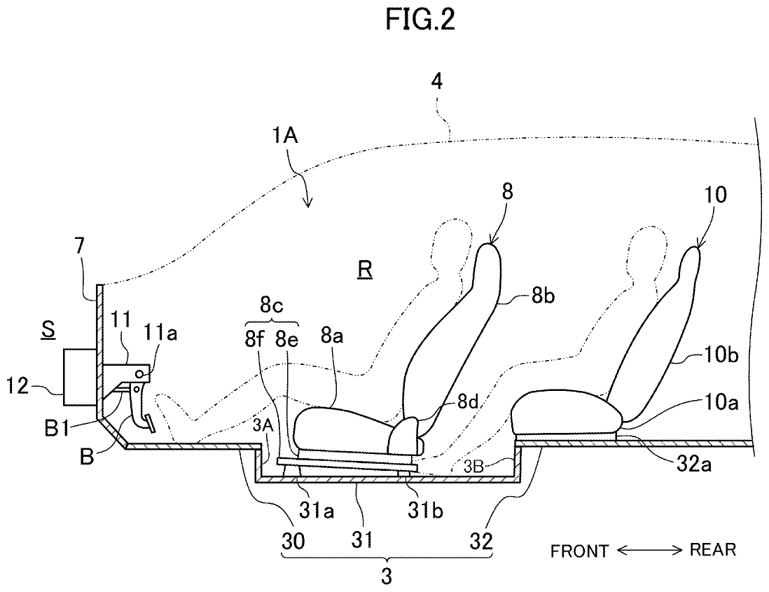

In the motor vehicle 1, a vehicle interior R is provided at the rear of the power house S, as shown in FIG. 2. A bottom surface of the vehicle interior R is formed by a floor panel 3, and therefore, a space above the floor panel 3 is the vehicle interior R. A roof 4 is provided above the vehicle interior R. Further, as shown in FIG. 1, a front door 5 and a rear door 6 are arranged in an openable/closable manner at a left portion of the motor vehicle 1. Note that a front door and a rear door are also arranged in an openable/closable manner on the right side of the motor vehicle 1, although not shown in the figure.

As shown in FIG. 2, the motor vehicle 1 has a vehicle body structure 1A of the present disclosure. Although the vehicle body structure 1A includes the floor panel 3 and a dash panel 7, the dash panel 7 may be a member not forming the vehicle body structure 1A of the present disclosure. A member dividing the vehicle interior R and the power house S from each other in the front-rear direction is the dash panel 7. The dash panel 7 is made of, e.g., a steel plate, and extends not only in the right-left direction but also in the up-down direction. A lower portion of the dash panel 7 is inclined or curved so as to be positioned rearward toward a lower end portion thereof, and a lower end portion of the dash panel 7 is connected to a front end portion of the floor panel 3. Thus, the floor panel 3 is provided so as to extend rearward from the lower end portion of the dash panel 7.

In this embodiment, the right side of the vehicle interior R is a driver seat side, and the left side of the vehicle interior R is a passenger seat side. FIG. 2 is a cross-sectional view of the driver seat side of the motor vehicle 1, and shows the cross sections of the floor panel 3 and the dash panel 7 and a schematic structure of a driver seat 8 and a rear seat 10 attached to the floor panel 3 as well as a brake pedal B attached to the dash panel 7. While the driver seat 8 is provided on the right side of a center portion of the vehicle interior R in the right-left direction, a passenger seat 9 (shown in FIG. 1) is provided on the left side of the center portion of the vehicle interior R in the right-left direction. Note that the present disclosure is not limited to above, and the driver seat side may be on the left side of the vehicle interior R and the passenger seat side may be on the right side of the vehicle interior R. Further, there may be two or more rows of rear seats in the vehicle interior R.

The brake pedal B is swingably provided at the dash panel 7. That is, in the vehicle interior R on the right side of the dash panel 7, a pedal bracket 11 is attached to a portion facing the driver seat 8. The pedal bracket 11 is provided away upward from an upper surface of the floor panel 3. A spindle 11a extending in the right-left direction is provided at the pedal bracket 11. An upper end portion of the brake pedal B is pivotably supported on the spindle 11a.

The brake pedal B extends downward from the portion supported by the spindle 11a. A lower end portion of the brake pedal B is a portion to be stepped on by an occupant. A rear end portion of a rod B1 is coupled to the brake pedal B. A front end portion of the rod B1 is connected to an input of a brake booster apparatus 12. Note that the front end portion of the rod B1 may be coupled to a brake force generation apparatus other than the brake booster apparatus 12.

Note that the support structure of the brake pedal B is not limited to one described above and the brake pedal B may be a so-called organ pedal type brake pedal although not shown in the figure. In this case, a lower portion of the brake pedal is swingably supported on the floor panel 3 through a spindle extending in the right-left direction.

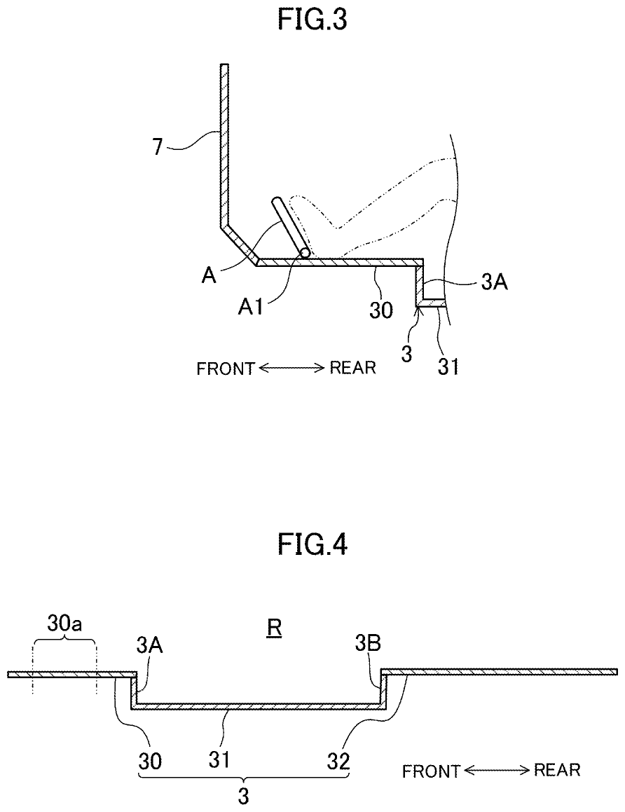

FIG. 3 is a cross-sectional view of the dash panel 7 and the floor panel 3, and shows the position of an accelerator pedal A. The accelerator pedal A is of a so-called organ pedal type, and a lower portion of the accelerator pedal A is swingably supported to the floor panel 3 through a spindle A1 extending in the right-left direction. Note that although not shown in the figure, the accelerator pedal A may be of a hanging type. In this case, an upper portion of the accelerator pedal A is swingably supported on the dash panel 7 via the spindle extending in the right-left direction. The motor vehicle 1 driven by the traction motor also includes a pedal to be operated upon acceleration, and such a pedal will be also referred to as an accelerator pedal in the present specification.

Although not shown in the figure, in a case where a manual transmission, whose gear ratio is changed by an occupant using an operation lever (not shown) provided in the vehicle interior R, is mounted, a pedal for operating a clutch is provided in the vehicle interior R. Normally, the accelerator pedal A is arranged at the rightmost position, the brake pedal B is arranged at the left of the accelerator pedal A, and a clutch pedal is arranged at the left of the brake pedal B.

Further, for example, in an instruction vehicle used for a motor vehicle driving course, an accelerator pedal and a brake pedal are also provided on a passenger seat side as in a driver seat side, although not shown in the figure. The present disclosure is also applicable to such an instruction vehicle.

(Configuration of Floor Panel)

As shown in FIG. 4, the floor panel 3 includes a front floor panel 30, a middle floor panel 31, and a rear floor panel 32. The front floor panel 30, the middle floor panel 31, and the rear floor panel 32 are formed by separate members, and are joined to each other to form the floor panel 3. Although not shown in the figure, a floor tunnel portion may be formed at the front floor panel 30 and the middle floor panel 31. The floor tunnel portion can be formed in such a manner that center portions of the front floor panel 30 and the middle floor panel 31 in the right-left direction bulge upward, and for example, may be formed so as to continuously extend in the front-rear direction from a front portion of the front floor panel 30 to a rear portion of the middle floor panel 31.

The front floor panel 30 extends rearward from the lower end portion of the dash panel 7, and extends in the right-left direction. A heel rest portion 30a on which a heel of the pedal operator operating the brake pedal B and the accelerator pedal A is placed is provided at the front floor panel 30. The heel rest portion 30a is a portion where the heel of the occupant is naturally placed when the occupant operates the accelerator pedal A or the brake pedal B. This portion varies to some extent according to the physique, driving postures, etc. of the occupant, but is generally an area (region) shown in FIG. 4. That is, the heel rest portion 30a can be defined as a continuous region from a portion away rearward from a front end portion of the front floor panel 30 to a portion away forward from a rear end portion of the front floor panel 30, and can also be a middle portion of the front floor panel 30 in the front-rear direction.

As shown in FIG. 2, the rear floor panel 32 is a member provided away rearward from the front floor panel 30 and attached to the rear seat 10. The rear seat 10 includes a rear-seat cushion portion 10a forming a seat surface and a rear-seat seat back portion 10b forming a back rest portion. The rear-seat cushion portion 10a is fixed to an upper surface of the rear floor panel 32.

Although the rear floor panel 32 is continuously formed at least from a portion corresponding to a front end portion to a portion corresponding to a rear end portion of the rear-seat cushion portion 10a, the rear floor panel 32 may be extended rearward beyond the rear end portion of the rear-seat cushion portion 10a. In this case, a rear seat of a second row or a luggage compartment for placing luggage can be provided at the rear of the rear seat 10.

The middle floor panel 31 extends from a rear portion of the front floor panel 30 to a front portion of the rear floor panel 32. The front floor panel 30 and the rear floor panel 32 are positioned higher than the middle floor panel 31. That is, for example, the front floor panel 30 can be formed so as to extend substantially horizontally in the front-rear direction, and the middle floor panel 31 can also be formed so as to extend substantially horizontally in the front-rear direction. In this case, since the front floor panel 30 is positioned higher than the middle floor panel 31, the floor panel 3 includes a front plate portion 3A extending in the up-down direction from the rear portion of the front floor panel 30 to the front portion of the middle floor panel 31. Since the front floor panel 30 and the middle floor panel 31 are connected to each other through the front plate portion 3A, there is a step between the front floor panel 30 and the middle floor panel 31.

Further, the rear floor panel 32 can also be formed so as to extend substantially horizontally in the front-rear direction. In this case, since the rear floor panel 32 is positioned higher than the middle floor panel 31, the floor panel 3 includes a rear plate portion 3B extending in the up-down direction from the front portion of the rear floor panel 32 to the rear portion of the middle floor panel 31. Since the rear floor panel 32 and the middle floor panel 31 are connected to each other through the rear plate portion 3B, there is a step between the rear floor panel 32 and the middle floor panel 31. Thus, the middle floor panel 31 is positioned one step lower than the front floor panel 30 and the rear floor panel 32. A difference in a height between the middle floor panel 31 and each of the front floor panel 30 and the rear floor panel 32 may be set to, for example, 5 cm or more, 10 cm or more, or 15 cm or more. The front floor panel 30 and the rear floor panel 32 may be at the same height, or the front floor panel 30 may be lower or higher than the rear floor panel 32. Further, the front floor panel 30, the middle floor panel 31, and the rear floor panel 32 are not necessarily precisely horizontal, and may be inclined so as to be positioned downward toward the rear side. Further, only part of the front floor panel 30, the middle floor panel 31, and the rear floor panel 32 may be inclined, and the remaining part may be substantially horizontal.

The front plate portion 3A may be integrally formed with the front floor panel 30 or with the middle floor panel 31. Alternatively, the front plate portion 3A may be formed separately from these floor panels 30, 31. The rear plate portion 3B may be integrally formed with the rear floor panel 32 or with the middle floor panel 31. Alternatively, the rear plate portion 3B may be formed separately from these floor panels 31, 32. Further, the front plate portion 3A and the rear plate portion 3B may extend substantially vertically, or may be inclined or curved. For example, the front plate portion 3A may be inclined or curved so as to be positioned rearward toward the lower side, and the rear plate portion 3B may be inclined or curved so as to be positioned forward toward the lower side.

As shown in FIG. 2, the middle floor panel 31 has a first front-seat fixing portion (a front seat fixing portion) 31a and a second front-seat fixing portion (a rear seat fixing portion) 31b for fixing the front seat 8. The first front-seat fixing portion 31a is provided at the front of a center portion of the middle floor panel 31 in the front-rear direction, and for example, includes a member fixed to the middle floor panel 31 and formed long in the right-left direction. Similarly, the second front-seat fixing portion 31b also includes a member formed long in the right-left direction, and is provided a predetermined distance away rearward from the first front-seat fixing portion 31a. The configurations of the first front-seat fixing portion 31a and the second front-seat fixing portion 31b are not limited to the members as described above, and may be members formed in various shapes by plate members etc. Note that in this embodiment, the first front-seat fixing portion 31a is formed so as to be higher than the second front-seat fixing portion 31b. However, the heights of the first front-seat fixing portion 31a and the second front-seat fixing portion 31b may be the same as each other.

A rear-seat fixing portion 32a for fixing the rear seat 10 is provided at least at a front portion of the rear floor panel 32. The rear-seat fixing portion 32a may be configured similarly to or differently from the front-seat fixing portions 31a, 31b.

(Front Seat)

The front seat 8 includes a front-seat cushion portion 8a, a front-seat seat back portion 8b, and a seat slide mechanism 8c configured to adjust the position of the front-seat cushion portion 8a in the front-rear direction. The front-seat cushion portion 8a is a portion forming a seat surface for a front seat occupant, and although not shown in the figure, includes, for example, a seat frame, a cushion material supported on the seat frame, and a cover material covering the cushion material. The front-seat seat back portion 8b is a portion forming a back rest portion for the front seat occupant, and although not shown in the figure, includes a seat frame, a cushion material, a cover material, etc.

A lower portion of the front-seat seat back portion 8b is attached to a rear portion of the front-seat cushion portion 8a through a reclining mechanism 8d. The reclining mechanism 8d is typically well-known, and is a mechanism for fixing the front-seat seat back portion 8b at an optional inclination angle.

The seat slide mechanism 8c can be a typical well-known mechanism, and for example, includes a movable member 8e fixed to the front-seat cushion portion 8a and a rail 8f fixed to the first front-seat fixing portion 31a and the second front-seat fixing portion 31b on the middle floor panel 31. The rail 8f is a member for guiding the front-seat cushion portion 8a in the front-rear direction, and extends in the front-rear direction. A front portion of the rail 8f is fixed to the first front-seat fixing portion 31a, and a rear portion of the rail 8f is fixed to the second front-seat fixing portion 31b. Since the first front-seat fixing portion 31a is higher than the second front-seat fixing portion 31b, the rail 8f is inclined so as to be positioned upward toward the front. The rail 8f may be substantially horizontal.

The movable member 8e is a member capable of moving relative to the rail 8f in the front-rear direction while being engaged with the rail 8f. The position of the movable member 8e with respect to the rail 8f in the front-rear direction can be an optional position within a predetermined range, and the movable member 8e can be locked to the rail 8f at such a position. Such a lock mechanism is also typically well-known, and for example, can be unlocked by, e.g., lever operation. Note that the seat slide mechanism 8c and the reclining mechanism 8d may be of an electric type using an electric motor.

The height of the seat slide mechanism 8c can be set according to the height of the middle floor panel 31, the height of the first front-seat fixing portion 31a, and the height of the second front-seat fixing portion 31b. In this embodiment, the height of the seat slide mechanism 8c is set such that the front floor panel 30 is at a position higher than the seat slide mechanism 8c when compared with the front floor panel 30.

(Rear Seat)

The rear seat 10 includes the rear-seat cushion portion 10a and the rear-seat seat back portion 10b. The rear-seat cushion portion 10a and the rear-seat seat back portion 10b can be configured similarly to those in the front seat 8. The rear-seat cushion portion 10a is fixed to the rear-seat fixing portion 32a on the rear floor panel 32. Note that the rear seat 10 may be also provided with a seat slide mechanism and a reclining mechanism similar to those of the front seat 8.

(Posture of Front Seat Occupant and Pedal Operation)

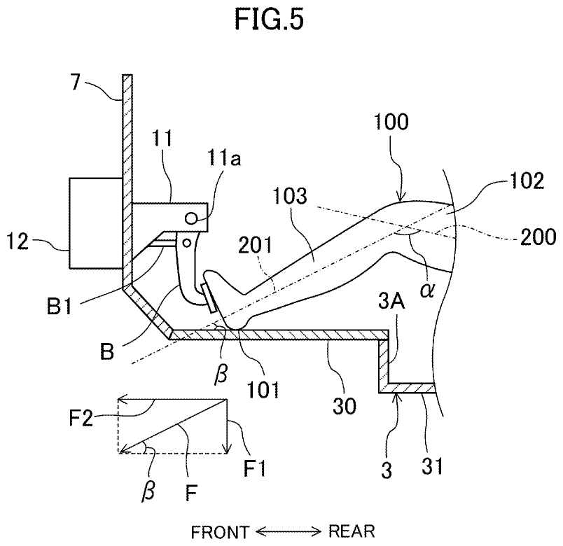

FIG. 5 is a view showing a lower limb 100 of the front seat occupant (a pedal operator) seated on the front seat 8, the floor panel 3, the dash panel 7, the brake pedal B, and the vicinity thereof. In this embodiment, the front seat 8 is fixed to the middle floor panel 31 positioned lower than the front floor panel 30. Thus, the hip point of the pedal operator can be lowered. Lowering the hip point of the pedal operator means that the seating position of the pedal operator is lowered. This lowers the height of the center of gravity of the vehicle while the occupant is on-board.

Further, since the front floor panel 30 on which a heel 101 of the pedal operator is placed is positioned higher than the middle floor panel 31, the heel 101 of the pedal operator is placed at a position higher as compared to a general operation posture. Such a layout leads to such a posture that an upper leg 102 and a lower leg 103 of the pedal operator are widely open. In FIG. 5, a reference numeral 200 indicates the center line of the upper leg 102 of the pedal operator whereas a reference numeral 201 indicates the center line of the lower leg 103, and a difference in a height between the front floor panel 30 and the middle floor panel 31 is set such that an angle (an opening angle α between the upper leg 102 and the lower leg 103) between the center lines 200, 201 falls within a range of 125° to 150°.

Setting the height difference as described above results in a smaller angle (angle β between the center line 201 and the front floor panel 30) between the lower limb 103 and the front floor panel 30. This decreases component force, which is input to the heel 101 upon pedal operation, in the up-down direction, and improves the operability of the brake pedal B. More specifically, when the pedal operator steps on the brake pedal B, the heel 101 causes obliquely-downward force F to act on the front floor panel 30. When divided into vertical force and horizontal force, the force F is divided into force F1 and force F2. Since the angle β is small as described above, the component force F1, which is input from the heel 101, in the up-down direction is reduced. This allows, e.g., the quick and accurate operation of switching the pedal to be stepped on from the brake pedal B to the accelerator pedal A or from the accelerator pedal A to the brake pedal B. As a result, the operability of the pedals A, B is improved.

(Comfort of Rear Seat Occupant)

As shown in FIG. 2, since the rear floor panel 32 to which the rear seat 10 is attached is positioned higher than the middle floor panel 31, an occupant on the rear seat 10 is seated at a relatively-high position, which improves the field of view. The feet of the rear seat occupant are placed on the middle floor panel 31. Since the middle floor panel 31 is positioned lower than the rear floor panel 32, a wide foot space for the rear seat occupant is ensured particularly in the height direction.

### Features and Advantages of Embodiment

As described above, according to this embodiment, the pedal operability can be improved by the small angle β between the lower leg 103 of the pedal operator and the front floor panel 30 while a wide foot space for the occupant seated on the rear seat 10 is ensured.

Further, since the seat fixing portions 31a, 31b are provided on the middle floor panel 31 positioned lower than the front floor panel 30, the hip point of the pedal operator seated on the front seat 8 is lowered. This can achieve a sufficiently-small angle β between the lower leg 103 of the pedal operator and the front floor panel 30.

### OTHER EMBODIMENTS

The above-described embodiments are merely examples in nature in all respects, and the scope of the present disclosure should not be interpreted in a limited manner. Further, variations and modifications of equivalents of the patent claims are intended to fall within the scope of the present disclosure.

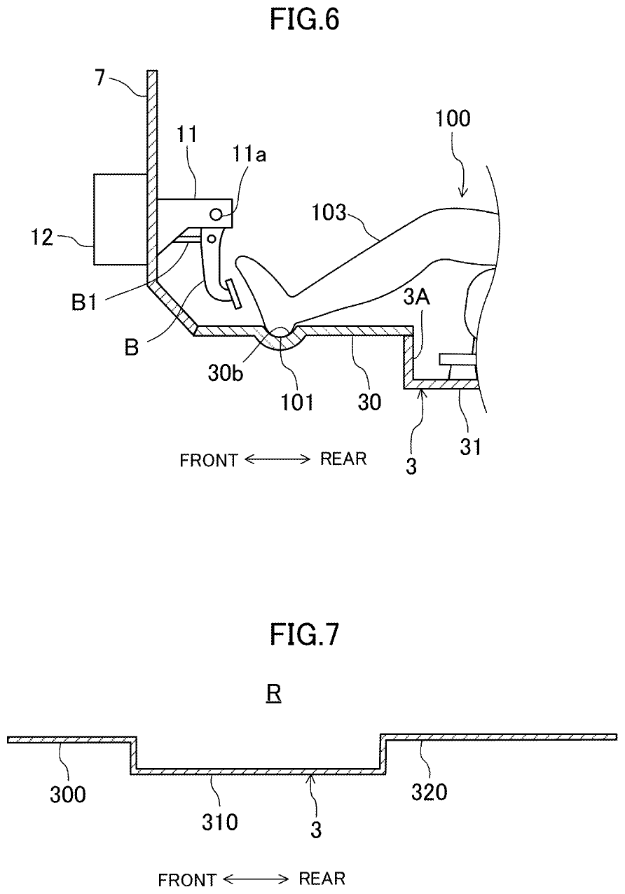

For example, in Variation 1 of the embodiment shown in FIG. 6, the front floor panel 30 has, at a portion corresponding to the brake pedal B, a recessed portion 30b for placing the heel 101 of the pedal operator. It may only be required that the depth of the recessed portion 30b is set so as to house at least part of a heel portion of a shoe, and the depth can be 2 cm or more or 3 cm or more, for example. Since the pedal operability might be degraded if the recessed portion 30b is extremely deep, the depth may be 7 cm or less, for example. The width (the dimension in the right-left direction) of the recessed portion 30b can be, for example, 5 cm or more or 7 cm or more.

With the recessed portion 30b, the heel 101 is less likely to shift in the right-left direction. This can make the foot stable in the case of turning a toe in the right-left direction about the vicinity of the heel 101, such as the case of stepping on the accelerator pedal A after having stepped on the brake pedal B, for example. As a result, the pedal operability can be further improved by a synergy effect with the above-described advantage of the small angle β between the lower leg 103 of the pedal operator and the front floor panel 30.

Further, as in, e.g., Variation 2 of the embodiment shown in FIG. 7, the floor panel 3 may be a single piece from the front portion to the rear portion. Specifically, the floor panel 3 of Variation 2 includes a front panel portion 300 for placing the heel of the pedal operator, a rear panel portion 320 provided away rearward from the front panel portion 300 and attached to the rear seat 10, and a middle panel portion 310 extending from a rear portion of the front panel portion 300 to a front portion of the rear panel portion 320. The front panel portion 300 and the rear panel portion 320 are positioned higher than the middle panel portion 310. The front panel portion 300 is equivalent to the above-described front floor panel 30, the middle panel portion 310 is equivalent to the above-described middle floor panel 31, and the rear panel portion 320 is equivalent to the above-described rear floor panel 32. In Variation 2, features and advantages similar to those of the above-described embodiment can be also obtained. Alternatively, the front panel portion 300 and the middle panel portion 310 may be integrally formed, and the rear panel portion 320 may be a separate member. Alternatively, the rear panel portion 320 and the middle panel portion 310 may be integrally formed, and the front panel portion 300 may be a separate member.

As described above, the vehicle body structure of the present disclosure is applicable to a motor vehicle having a floor panel, for example.

What is claimed is:

1. A vehicle body structure including a floor panel forming a floor surface of a vehicle interior in which a front seat and a rear seat are provided, comprising:
a front floor panel on which a heel of a pedal operator operating a pedal provided in the vehicle is placed;
a rear floor panel provided away rearward from the front floor panel and attached to the rear seat; and
a middle floor panel extending from a rear portion of the front floor panel to a front portion of the rear floor panel,
the front floor panel and the rear floor panel being positioned higher than the middle floor panel.

2. The vehicle body structure of claim 1, wherein
the middle floor panel has a seat fixing portion for fixing the front seat.

3. The vehicle body structure of claim 2, wherein
the front seat includes a front-seat cushion portion and a seat slide mechanism configured to adjust a position of the front-seat cushion portion in a vehicle front-rear direction, and
the middle floor panel includes a front seat fixing portion for fixing a front portion of the seat slide mechanism and a rear seat fixing portion for fixing a rear portion of the seat slide mechanism.

4. The vehicle body structure of claim 3, wherein
the front floor panel is positioned higher than the seat slide mechanism.

5. The vehicle body structure of claim 4, wherein
the front floor panel has, at a portion corresponding to a brake pedal, a recessed portion for placing a heel of the pedal operator.

6. A vehicle body structure comprising:
a floor panel forming a floor surface of a vehicle interior in which a front seat and a rear seat are provided,
the floor panel including
a front panel portion for placing a heel of a pedal operator operating a pedal provided in the vehicle,
a rear panel portion provided away rearward from the front panel portion and attached to the rear seat, and
a middle panel portion extending from a rear portion of the front panel portion to a front portion of the rear panel portion,
the front panel portion and the rear panel portion being positioned higher than the middle panel portion.

7. The vehicle body structure of claim 1, wherein
the front floor panel has, at a portion corresponding to a brake pedal, a recessed portion for placing a heel of the pedal operator.

8. The vehicle body structure of claim 2, wherein
the front floor panel has, at a portion corresponding to a brake pedal, a recessed portion for placing a heel of the pedal operator.

9. The vehicle body structure of claim 3, wherein
the front floor panel has, at a portion corresponding to a brake pedal, a recessed portion for placing a heel of the pedal operator.
